(19) United States
(12) Patent Application Publication
(10) Pub. No.: US 2008/0202865 A1
(43) Pub. Date: Aug. 28, 2008

(54) Wheel Brake Comprising a Wear Sensor

(76) Inventors: Jean Clair Pradier, Houilles (FR); Max Erick Busse-Grawitz, Suisse (DE)

Correspondence Address: YOUNG & THOMPSON, 209 Madison Street, Suite 500, ALEXANDRIA, VA, 22314, US

(21) Appl. No.: 11/660,788

(22) PCT Filed: Aug. 26, 2005
(86) PCT No.: PCT/FR05/02158

§ 371 Date: Dec. 6, 2007

(30) Foreign Application Priority Data
Aug. 26, 2004 (FR) 0409119

(51) Int. Cl. F16D 66/02

(52) U.S. Cl. 188/1.11 W

(57) ABSTRACT

A brake for a vehicle wheel which is mounted in such a way that it can be rotated in relation to a wheel support, the brake including a frame which is fixed to the wheel support, and additional mobile and fixed friction elements. The inventive brake also includes a device for measuring a parameter representing the energetic capacity of the brake. The measuring device includes a capacitive sensor and an information processing unit, the capacitive sensor having two measuring reinforcements mounted face-to-face and carried by the frame, and a dielectric screen carried by a friction element which can be displaced by the action of each actuator. The dielectric screen slides between the two reinforcements during the clamping of the friction elements in order to modify the capacity of the condenser formed by the two measuring reinforcements. The brake is useful in an aeroplane.

The present invention relates to a brake for a vehicle wheel mounted to rotate relative to a wheel support, the brake being of the type comprising a frame for being secured to the wheel support, and complementary moving and stationary friction members, the moving friction members being for securing to the wheel, and the stationary friction members being constrained in rotation with the frame, the brake including at least one actuator carried by the frame and adapted to press the complementary friction members against one another along the axis of the wheel, and also including a measurement device for measuring a parameter representative of the energy capacity of the brake.

Vehicles, in particular airplanes, are fitted with friction braking devices. In use, the friction members wear away progressively. In order to manage replacement of the friction members as well as possible, it is known to track their wear over time.

Airplane brakes are fitted with a stack of disks that are connected in alternation to the wheel and to the wheel support. During braking, these disks are pressed against one another by actuators.

In order to track brake disk wear, the end disk of the stack is connected to a “wear” pin that projects parallel to the axis of the wheel. This pin is engaged through a reference orifice carried by the wheel support, and more precisely formed through the brake frame. The distance between the end of the pin and the orifice through which the pin is engaged is representative of disk wear. This distance is conventionally measured manually by an operator to determine the length of the wear pin, e.g. by using a ruler.

Document U.S. Pat. No. 6,659,233 describes the possibility of placing an optical encoder on the wear pin, the encoder being constituted by a set of graduations carried by the wear pin and by an optical encoder suitable for determining the number of graduations that go past the encoder.

Such an optical sensor is very difficult to implement in the very constrained environment of a brake, because of high levels of vibration, very high temperatures, and the carbon dust given off by the disks.

An object of the invention is to provide a brake that enables wear to be measured and that is simple and reliable in spite of the severe operating conditions.

To this end, the invention provides a brake for a wheel mounted to rotate relative to a wheel support and of the above-specified type, the brake being characterized in that the measurement device comprises a capacitive sensor and an information processor unit connected to the capacitive sensor, which capacitive sensor comprises two measurement plates disposed facing each other and carried by the frame, and a dielectric screen carried by a friction member, which screen, moving under drive from the or each actuator, is slidable between the two plates while the friction members are being pressed together, thereby changing the capacitance of the capacitor formed by the two measurement plates.

In particular embodiments, the brake includes one or more of the following characteristics:

the two plates are formed by cylindrical plates of curved section that are generally symmetrical to each other about a middle axis along which the dielectric screen is movable;

the two plates are formed by pins that are generally symmetrical to each other about a middle axis along which the dielectric screen is movable;

the plates form a housing defining a cavity in which there are received the other plate and at least part of the dielectric screen;

the plates extend generally parallel to the direction in which the friction members are pressed together;

the dielectric screen is generally in the form of a pin extending along the axis along which the friction members are pressed together;

an insulating insert is interposed between the two plates and the dielectric screen to provide the dielectric screen with mechanical guidance; and

an airplane landing brake comprising a wheel support, a wheel, and a brake as defined above.

The invention can be better understood on reading the following description given purely by way of example and made with reference to the drawings, in which:

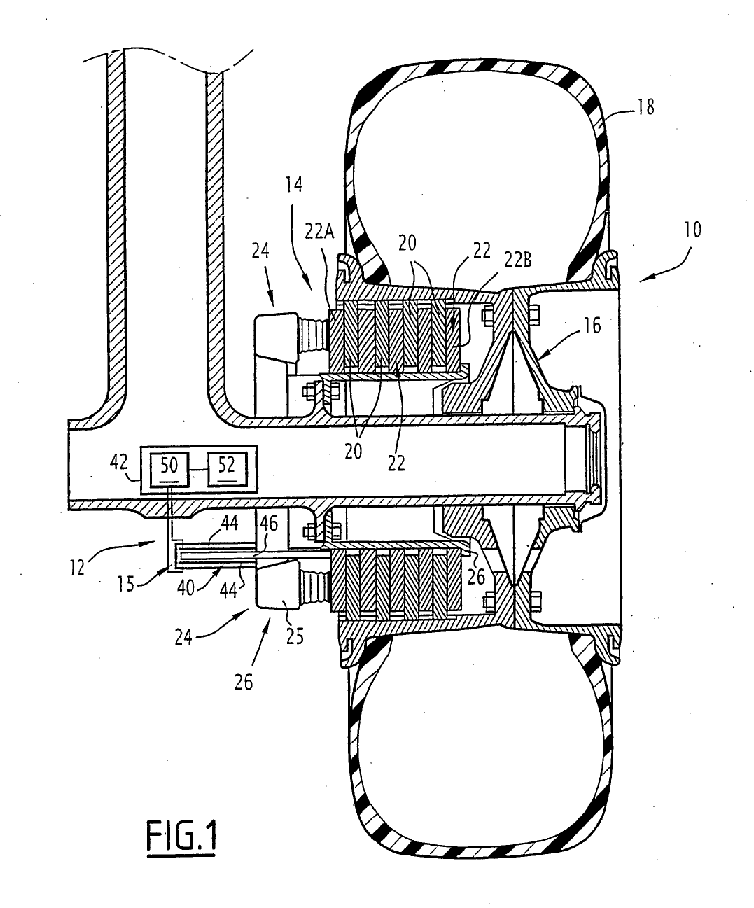

FIG. 1 is a cross-section view of an aircraft wheel fitted with a brake device of the invention;

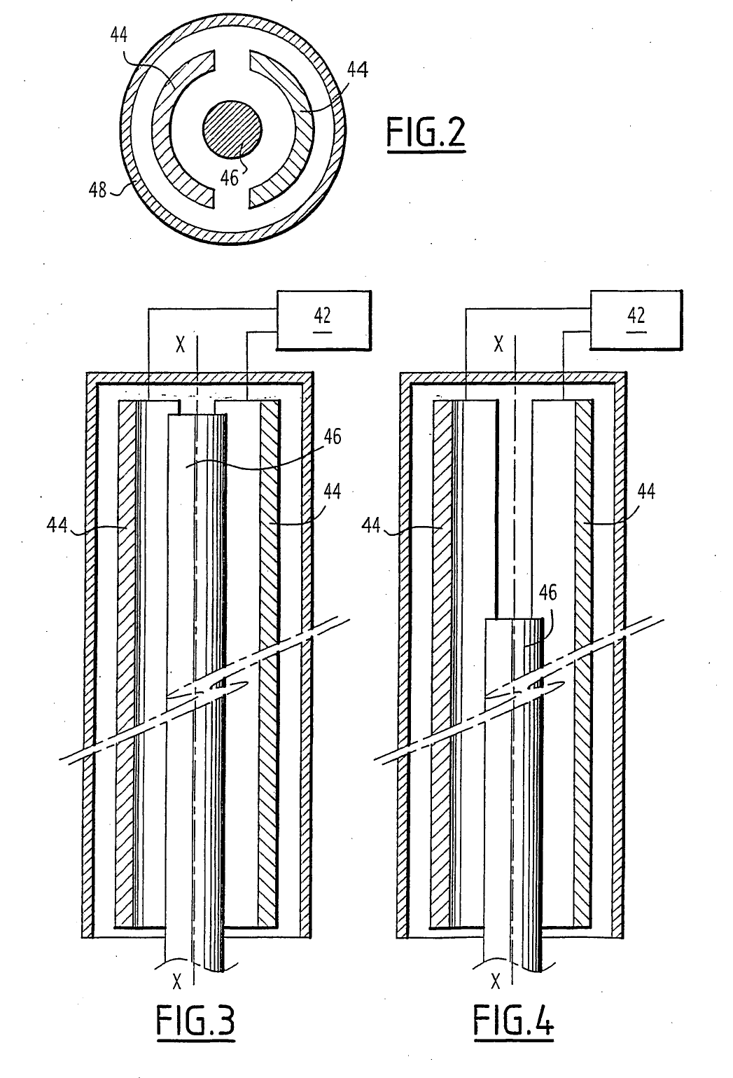

FIG. 2 is a section view of a first embodiment of a capacitive sensor of the invention;

FIGS. 3 and 4 are longitudinal section views of the capacitive sensor of the invention shown in distinct positions;

FIG. 5 is a view identical to that of FIG. 2, showing a variant embodiment of the capacitive sensor; and

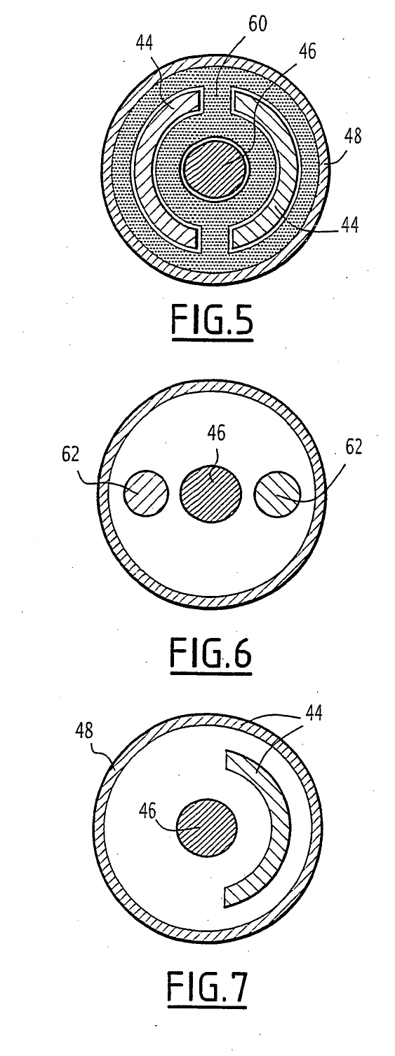

FIGS. 6 and 7 are views analogous to the view of FIG. 2 showing variant embodiments of the sensor.

FIG. 1 shows an aircraft wheel 10 mounted to rotate about a wheel support 12 constituting a spindle. The wheel 10 is fitted with a brake 14, itself fitted with a wear-measurement device 15.

The wheel 12 presents a rim 16 on which a tire 18 is mounted.

In known manner, the brake 14 comprises a stack of complementary friction members carried by the wheel support 12 and by the rim 16.

These complementary friction members comprise a set of moving disks 20 constrained to rotate with the rim 16. These disks are disposed in such a manner that their axis extends along the axis of rotation of the wheel. They are constrained to rotate with the wheel by means of notches formed in the rim 16. The disks 20 are free to move in translation relative to the rim along the axis of the wheel over a predefined travel stroke.

In addition, the friction members also comprise complementary disks 22 that are stationary and interposed between the disks 20. The disks 22 are prevented from rotating relative to the wheel support 12 and they are movable in translation relative to said support along the axis of rotation of the wheel.

The disks 20 and 22 are interleaved. While the brakes are being applied, the disks are pressed against one another along the direction of the axis of rotation of the wheel by a set of actuators 24, each actuator having a stationary portion secured to an annular frame 25 of the brake. The frame 25 is stationary both axially and in rotation relative to the wheel support 12.

The moving portions of the actuators are adapted to press against an end disk referenced 22A of the stack of disks 20 and 22. The other end of this stack presses against a shoulder 26 via an end disk 22B that is axially secured to the support wheel 12 and to the brake frame 25.

The actuators act in a direction parallel to the axis of rotation of the wheel.

The wear-measurement device 15 is suitable for determining a parameter that is representative of the wear of the brake, and specifically of the energy capacity of the brake. The energy capacity is representative of the energy that can still be dissipated by the brake before it is necessary to change the disks. It depends on the remaining volume of the friction members.

The measurement device 15 comprises a capacitive sensor 40 and an information processor unit 42 connected to the sensor.

The capacitive sensor 40 comprises two identical plates 44 placed facing each other. The plates are electrically conductive and are covered in insulation. For example, they are made of metal. The plates are supported by the frame 25 and they are held stationary in position relative thereto.

In the embodiment shown in FIGS. 1 to 4, both plates are formed by cylindrical plates of curved section disposed symmetrically about a longitudinal middle axis of the sensor, referenced X-X. This axis extends parallel to the axis of rotation of the wheel.

The length of the plates 44 is greater than the maximum allowable displacement of the end disk 22A as a result of wear of the friction members.

A dielectric screen 46, e.g. constituted by a cylindrical pin, is slidably mounted between the two plates 44. By way of example, it is made of steel. This dielectric screen is connected at one end to the end disk 22A.

The screen extends along the axis X-X parallel to the axis of rotation of the wheel, i.e. perpendicularly to the plane of the disk 22A. It is disposed at a distance from the plates 44 and passes through the frame 25 without making contact therewith.

The length of the screen is greater than the length of the plates 44. It is displaceable together with the end disk 22A between a position in which it is fully engaged between the two plates 44, as shown in FIG. 3, and a position in which it is engaged in part only between the plates, as shown in FIG. 4.

The fully-engaged position, in which the screen lies between the plates 44 over the entire length of the plates, corresponds to the position of the screen when the friction members 20, 22 are new. In contrast, the partially-engaged position of FIG. 4 corresponds to the friction members 20, 22 being partially or fully worn, such that the screen extends in part only between the two plates when the brake is applied.

The sensor 40 also includes a housing 48, preferably made of metal, that completely contains the plates 44.

The screen 46 is connected to ground. The plates 44 are connected to two terminals of the information processor unit 42.

This unit includes conventional means 50 for measuring the capacitance of the capacitor formed by the plates 44. By way of example, these means may comprise a Wheatstone bridge having the capacitive sensor included therein, the bridge being powered in known manner by an appropriate generator.

The information processor unit also includes a processor 52 connected to the measurement means 50 and suitable for deducing therefrom the thickness of the disk on the basis of the capacitance as measured between the two plates 44 of the capacitive sensor. The processor 52 is also adapted to determine the energy capacity of the brake on the basis both of known dimensional data for the brake and of the thickness deduced for the disks.

In conventional manner, the brake acts by pressing the friction members against one another under drive from the actuators 24. While the friction members are being pressed together, the screen 46 moves between the plates 44 so as to reach a position that is set by the amount of wear the disks have suffered. In this position, the screen 44 extends between the plates 44 over a fraction only of their length, with the two plates 44 having only air between them beyond the end of the screen 46.

Insofar as the capacitance of the capacitor depends on the permeability of the material that is placed between the plates, and insofar as the permeability of the material constituting the screen 46 is different from, and in particular very much greater than, the permeability of air, the position of the pin along the length of the plates determines the capacitance of the capacitor. This capacitance is directly linked to the amount of brake wear, since it depends on the position of the screen 46.

On the basis of the capacitance of the capacitive sensor 40, the information processor unit 42 calculates the remaining energy capacity of the brake.

Use of a capacitive sensor makes it possible to obtain a wear-measurement device that is simple and relatively insensitive to the disturbed environment of the brake, which environment is particularly disturbed in terms of vibration and temperature levels.

Advantageously, and as shown in FIG. 5, a filler insert 60 is disposed between the plates 44, the screen 46, and the housing 48 so as to form a mechanical guide for guiding movement of the screen. This filler insert is made of a rigid and electrically-insulating material having ducts formed therein for forming the screen and the plates. The core also serves to provide mechanical support and retention for the plates 44.

Variant embodiments of the sensor are shown in FIGS. 6 and 7.

In the embodiment of FIG. 6, the plates 44 are constituted not by portions of a cylinder, but by circular-section pins 62 that are diametrically opposite about the travel axis X-X of the screen 46.

In the embodiment of FIG. 7, a single plate 44 is located inside the housing 48. The other plate 44 of the capacitive sensor is formed by the housing 48 itself, which is connected to the information processor unit 42 to form the second plate. In this embodiment likewise, the pin 46 is mounted to move inside a cavity defined by the housing 48 and separated from the facing faces of the plate 44 and the housing 48.

The use of a capacitive sensor in this particular application is found to provide much better performance than using a linear variable differential transformer (LVDT) type sensor.

1-8. (canceled)

9. A brake for a vehicle wheel mounted to rotate relative to a wheel support, the brake comprising a frame for being secured to the wheel support, and complementary moving and stationary friction members, the moving friction members being for securing to the wheel, and the stationary friction members being constrained in rotation with the frame, the brake including at least one actuator carried by the frame and adapted to press the complementary friction members against one another along the axis of the wheel, and also including a measurement device for measuring a parameter representative of the energy capacity of the brake, wherein the measurement device comprises a capacitive sensor and an information processor unit connected to the capacitive sensor, which capacitive sensor comprises two measurement plates disposed facing each other and carried by the frame, and a dielectric screen carried by a friction member, which screen, moving under drive from the or each actuator, is slidable between the two plates while the friction members are being pressed together, thereby changing the capacitance of the capacitor formed by the two measurement plates.

10. A brake according to claim 9, wherein the two plates are formed by cylindrical plates of curved section that are generally symmetrical to each other about a middle axis along which the dielectric screen is movable.

11. A brake according to claim 9, wherein the two plates are formed by pins that are generally symmetrical to each other about a middle axis along which the dielectric screen is movable.

12. A brake according to claim 9, wherein the plates form a housing defining a cavity in which there are received the other plate and at least part of the dielectric screen.

13. A brake according to claim 9, wherein the plates extend generally parallel to the direction in which the friction members are pressed together.

14. A brake according to claim 9, wherein the dielectric screen is generally in the form of a pin extending along the axis along which the friction members are pressed together.

15. A brake according to claim 9, wherein an insulating insert is interposed between the two plates and the dielectric screen to provide the dielectric screen with mechanical guidance.

16. An airplane landing brake comprising a wheel support, a wheel, and a brake according to claim 9.
